(19) United States
(12) Patent Application Publication
(10) Pub. No.: US 2007/0033961 A1
(43) Pub. Date: Feb. 15, 2007

(54) Machine for dispensing drinks, particularly of the cold water dispensers and "post-mix" systems type

(75) Inventor: Enrico Grampassi, Cervia (RA) (IT)

Correspondence Address: BROWDY AND NEIMARK, P.L.L.C.;624 NINTH STREET, NW, SUITE 300, WASHINGTON, DC, 20001-5303, US

(73) Assignee: Spm Drink Systems Srl, Spilamberto (MO) (IT)

(21) Appl. No.: 11/482,112

(22) Filed: Jul. 7, 2006

(30) Foreign Application Priority Data
Jul. 7, 2005 (IT) MO2005A000172

(51) Int. Cl. B67D 5/62

(52) U.S. Cl. 62/394; 62/389; 222/146.6

(57) ABSTRACT

The machine for dispensing drinks, particularly of the cold water dispensers and “post-mix” systems type, comprises a sealed tank for containing the water at a preset pressure, featuring a water inlet and a water outlet, a refrigeration unit featuring an evaporation unit arranged inside the tank, valve means placed in between the outlet and at least one dispenser point, means for supplying the water associated with the inlet and featuring at least one supply pipe of water at a pressure substantially above the preset pressure, and pressure limiting means associated with the supply pipe and able to reduce the pressure of the water to the preset pressure.

The present invention refers to a machine for dispensing drinks, particularly of the cold water dispensers and “post-mix” systems type.

Various types of machines are known able to cool water coming from the water mains supply and, if necessary, to mix this with a syrup by means of a so-called “post-mix” mixing system.

A particular type of these machines features an ice bank cooling system consisting of a refrigeration system, the evaporation unit of which is arranged inside an open-top, high-storage capacity (often variable) water tank.

The water inside the tank is not for drinking; in coming into contact with the evaporation unit in fact, it solidifies to form an ice bank of varying thickness, which acts as a means of absorbing heat to cool the actual drinking water, which runs inside a coil arranged spirally inside the tank.

The drinking water is cooled by transiting through the coil.

In the event of a “post-mix” mixing system being fitted, one or more secondary coils are introduced inside the tank, in which the syrups flow to be mixed with the drinking water.

This particular type of machines is not without drawbacks among which the fact that its production and maintenance costs are very high.

The high storage capacity of the tanks fitted to these machines also makes them considerably cumbersome, not very practical to use nor functional and distinguished by high levels of energy consumption.

It takes a lot of time and energy in fact to cool the water in the tank and complete the formation of the ice bank; before these machine are perfectly operative and cool water is available for drinking, it often takes 4-5 hours.

It should also be emphasised that these machines often cause excessive cooling of the aromatising syrup and, consequently, this tends to become very dense before being mixed with the drinking water.

In an alternative type of machine for dispensing cold water, possibly mixed with syrup, the drinking water is contained in an open-top tank and is directly in contact with the evaporation unit of the refrigeration system, which is fitted in the tank.

In such types of machines, the refrigeration system only cools the water and does not determine its solidification.

During dispensing, the water is taken from the tank by gravity and is conveyed to a chamber where the fast rotation of a motorised impeller permits mixing it with the aromatising syrup, coming from a corresponding container.

This second type of machine however is also susceptible to further upgrading, aimed especially at increasing performance in terms of cooling capacity and simplifying the structure.

The main aim of this invention is to eliminate the drawbacks of the known technique complained of above by excogitating a machine for dispensing drinks, particularly of the cold water dispensers and “post-mix” systems type, having compact dimensions and high performance in terms of drink cooling, making large quantities available for dispensing for a particularly long continuous time.

As part of such technical task, another purpose of this invention is to ensure high standards of hygiene.

Another purpose of the present invention is to achieve the previous aims with a simple structure, of relatively practical implementation, safe use and effective operation, as well as of a relatively low cost.

This aim and these purposes are all achieved by this machine for dispensing drinks, particularly of the cold water dispensers and “post-mix” systems type, characterized by the fact that it comprises a sealed tank for containing the water at a preset pressure, featuring at least one water inlet and at least one water outlet, a refrigeration unit featuring an evaporation unit arranged inside said tank, valve means placed in between said outlet and at least one dispenser point, means for supplying said water associated with said inlet and featuring at least one supply pipe of water at a pressure substantially above said preset pressure, and pressure limiting means associated with said supply pipe and able to reduce the pressure of the water to said preset pressure.

Further characteristics and advantages of the present invention will appear even more evident from the detailed description of a preferred, but not exclusive, form of embodiment of a machine for dispensing drinks, particularly of the cold water dispensers and “post-mix” systems type, illustrated by way of non limiting example in the accompanying drawings, wherein:

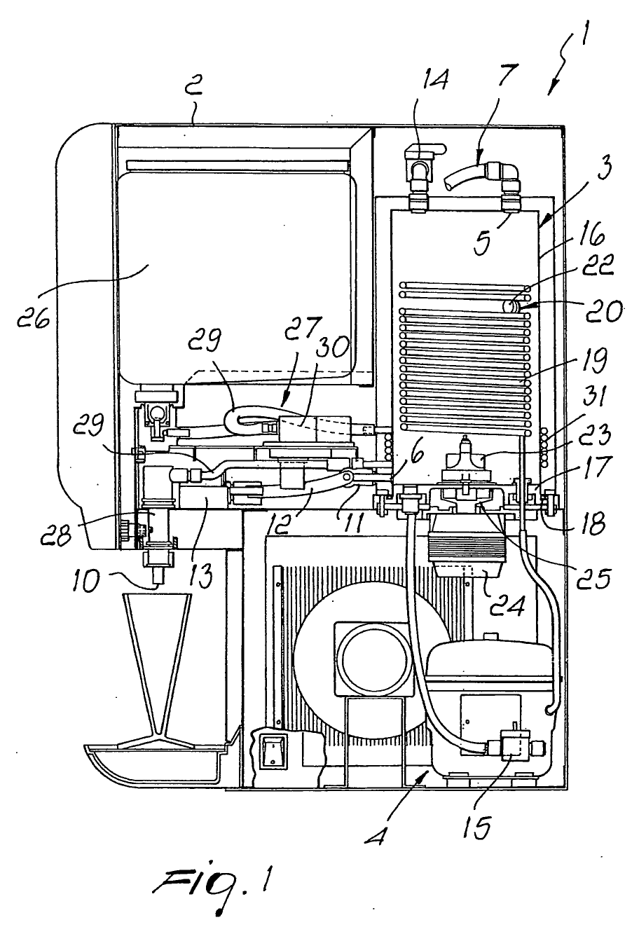

FIG. 1 is a side, schematic and partial view of the machine according to the invention;

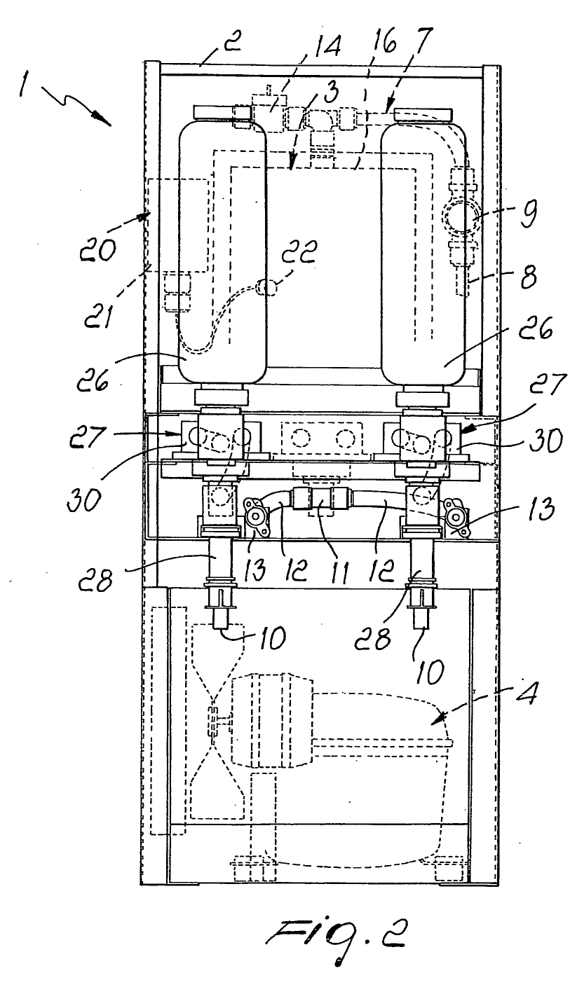

FIG. 2 is a front, schematic and partial view of the machine according to the invention;

With special reference to such figures, a machine for dispensing drinks, particularly of the cold water dispensers and “post-mix” systems type has been generally designated by reference numeral 1.

The machine 1 features a basic casing 2 containing a sealed tank 3 for holding water at a preset pressure, underneath which is positioned a refrigeration unit 4 for cooling the water.

The tank 3 features an inlet 5 and an outlet 6 for the water.

The inlet 5 is obtained at the top of the tank 3 and is associated with means for supplying 7 water, featuring a supply pipe 8 for supplying the water at a supply pressure substantially above the pressure preset inside the tank 3.

Along the supply pipe 8 pressure limiting means 9 are arranged able to reduce the pressure of water inside the tank 3 to the preset pressure.

Such limiting means consist of a valve that permits regulating the pressure inside the tank 3 and keeping it at the preset pressure.

The dispensing of a certain quantity of water through the outlet 6, in actual fact, causes a reduction in the pressure in the tank 3 and causes the pressure limiting valve 9 to open to allow a corresponding quantity of water to flow in to re-establish the pressure in the tank 3.

Usefully, the means for supplying 7 are directly associated with the normal water mains; in this case, the supply pressure of the water in the supply pipe 8 is determined by the pressure of the water in the water mains.

It cannot be ruled out however that the means for supplying 7 comprise one or more water storage tanks, and a pumping unit associated with the tank/s and able to pressurise the water at the above supply pressure.

The outlet 6 is obtained near the bottom of the tank 3 and communicates with a plurality of dispenser points 10 by means of the interposition of valve means that can be operated on command.

In particular, to the outlet 6 is associated a distribution manifold 11 from which the linking pipes 12 branch out to the valve means which, in detail, consist of a solenoid valve 13 for each dispenser point 10.

At the top of the tank 3 an air release valve 14 is fitted, which can be opened to allow the air to escape when the tank 3 is filled for the first time but which, during use, remains closed to keep the contents of the tank 3 at the preset pressure.

To the bottom of the tank 3 is also associated a drain valve 15 which, once the supply of water from the water mains is interrupted and once it is opened together with the release valve 14, permits fully emptying the tank 3 to perform, for example, maintenance, sanitizing jobs or the like.

The tank 3 can have varying overall capacity according to need; the invention however is able to achieve high performance in terms of cold water flow even with a not very high tank 3 capacity.

Advantageously, the tank 3 consists of a body 16 with a tubular shape and a round cross section, featuring a closed upper end and an open lower end that can be associated with a closing flange 17 by means of the interposition of water-tight sealing means 18.

The closing flange 17, in detail, is fitted integrally on the casing 2 and defines a housing seat for the sealing means 18, consisting in a seal ring made of rubber or the like.

In assembly configuration, the body 16 is arranged vertically and is fastened above the closing flange 17 which, in actual fact, represents the bottom of the tank 3.

The refrigeration unit 4 features an evaporation unit 19 arranged inside the tank 3 and able to form an ice bank.

Such evaporation unit consists of a stainless-steel coil or the like, which has a spiral configuration substantially coaxial to the body 16 and is arranged close to the side walls of the body itself.

The coil 19 can have different dimensions depending on the required refrigeration performance.

Furthermore, the refrigeration unit 4 comprises automated switch-on and switch-off means, not shown in detail in the illustrations, which in terms of operation are associated with the means of detection 20 of the ice bank thickness.

Usefully, the means of detection 20 comprise a control thermostat 21 the probe 22 of which is positioned among the spirals of the coil 19.

As long as the thickness of the ice bank remains below a preset value, the refrigeration unit 4 continues to cool the water; once the above preset value has been reached, on the other hand, the refrigeration unit 4 switches off.

The machine 1 features means for stirring the water inside the tank 3, which consist of an impeller 23, mounted above the closing flange 17, and of motor means 24, mounted underneath the closing flange 17 and associated with the impeller 23 by interposition of transmission means 25 of the magnetic motoring overtype.

The machine 1, as described thus far herein can correctly operate to dispense the drink at a particularly low temperature.

Conveniently, the special form of embodiment of the invention shown in the illustrations features a mixing system of the “post-mix” type that permits dispensing the water contained in the tank 3 combined with at least one aromatising substance which enhances the tastiness.

The machine 1, in particular, features a plurality of containers 26, one for each dispenser point 10, which contain the aromatising substances and are associated with conveying means 27 bringing the substances to a corresponding plurality of mixing chambers 28 with the water.

Such mixing chambers, arranged immediately downstream with respect to the solenoid valves 13 and upstream of the dispenser points 10, are nought else but the connection manifolds in which the residual water pressure favours the natural mixing of the water and the aromatising substances.

The conveying means 27 comprise a plurality of connecting pipes 29 of the containers 26 to the mixing chambers 28, along which are arranged means for pumping the aromatising substances, consisting of corresponding peristaltic pumps 30 that permit taking the substances from the containers 26 and conveying them to the mixing chambers 28.

The conveying means 27 also feature cooling means 31 of the aromatising substances, which consist of corresponding sections of the connecting pipes 29, made of stainless steel or the like and wrapped around the body 16.

Usefully, the body 16 is made of stainless steel or other heat-conducting material, so that the coil 19 which cools the water in the tank 3 is able to also cool the aromatising substances when these transit through the connecting pipes 29.

Other forms of embodiment of the invention are however possible in which the cooling means 31 are not fitted or are of a different type, such as, for example, a secondary refrigeration system separated from the tank 3; in this case, the body 16 can, if necessary, be made of plastic or other similar materials.

In practice it has been found that the described invention achieves the intended purposes and, in particular, emphasis is placed on the fact that it features high refrigeration performance since, inside the tank, the refrigeration unit only cools the water to be dispensed under conditions of maximum hygiene and, outside the tank, the aromatising substances are also cooled when transiting through the connecting pipes wrapped around the tank itself.

The invention thus conceived is susceptible of numerous modifications and variations, all of which falling within the scope of the inventive concept.

In one of these, for instance, this machine is not provided with the mixing system of the aromatising substances and operates as cold water dispenser only. Furthermore all the details can be replaced with others that are technically equivalent.

In practice, the materials used, as well as the shapes and dimensions, may be any according to requirements without because of this moving outside the protection scope of the following claims.

1) Machine for dispensing drinks, particularly of the cold water dispensers and “post-mix” systems type, characterized by the fact that it comprises a sealed tank for containing the water at a preset pressure, featuring at least one water inlet and at least one water outlet, a refrigeration unit featuring an evaporation unit arranged inside said tank, valve means placed in between said outlet and at least one dispenser point, means for supplying said water associated with said inlet and featuring at least one supply pipe of water at a pressure substantially above said preset pressure, and pressure limiting means associated with said supply pipe and able to reduce the pressure of the water to said preset pressure.

2) Machine according to claim 1, characterized by the fact that said evaporation unit is able to form at least one ice bank.

3) Machine according to claim 1, characterized by the fact that said means for supplying are associated with the normal water mains.

4) Machine according to claim 1, characterized by the fact that said means for supplying comprise at least one water storage cistern associated with a pumping unit of the water controlled by a pressure switch.

5) Machine according to claim 1, characterized by the fact that said inlet is obtained at the top of said tank.

6) Machine according to claim 1, characterized by the fact that said outlet is obtained near the bottom of said tank.

7) Machine according to claim 1, characterized by the fact that said tank comprises at least one body substantially with a tubular shape.

8) Machine according to claim 7, characterized by the fact that said body features a closed end and an open end that can be associated with a closing flange by means of the interposition of water-tight sealing means.

9) Machine according to claim 8, characterized by the fact that said water-tight sealing means consist of at least one seal ring.

10) Machine according to claim 8, characterized by the fact that said body is arranged substantially vertically and said closing flange represents its bottom.

11) Machine according to claim 1, characterized by the fact that said tank is made of one of the following materials: stainless steel, plastic or the like.

12) Machine according to claim 1, characterized by the fact that it comprises at least one water drain valve associated to the bottom of said tank.

13) Machine according to claim 1, characterized by the fact that it comprises at least one air release valve associated to the top of said tank.

14) Machine according to claim 1, characterized by the fact that said evaporation unit comprises at least one coil arranged spirally.

15) Machine according to claim 1, characterized by the fact that said tank comprises at least one body substantially with a tubular shape and said evaporation unit comprises at least one coil arranged spirally and substantially coaxial to said body.

16) Machine according to claim 1, characterized by the fact that said tank comprises at least one body substantially with a tubular shape and said evaporation unit comprises at least one coil arranged spirally close to the side walls of said body.

17) Machine according to claim 1, characterized by the fact that said evaporation unit is made of stainless steel or the like.

18) Machine according to claim 1, characterized by the fact that said refrigeration unit comprises automated switch-on and switch-off means associated with means of detection of said ice bank thickness.

19) Machine according to claim 18, characterized by the fact that said means of detection comprise at least one probe arranged close to said evaporation unit.

20) Machine according to claim 19, characterized by the fact that said evaporation unit comprises at least one coil arranged spirally and said probe is positioned among the spirals of said coil.

21) Machine according to claim 1, characterized by the fact that said valve means comprise at least one solenoid valve.

22) Machine according to claim 1, characterized by the fact that it comprises means for stirring the water inside said tank.

23) Machine according to claim 22, characterized by the fact that said means for stirring comprise at least one impeller, mounted inside said tank, and motor means associated with said impeller by interposition of motion transmission means.

24) Machine according to claim 23, characterized by the fact that said motion transmission means are of the magnetic motoring over type.

25) Machine according to claim 8, characterized by the fact that it comprises means for stirring the water inside said tank which are associated with said closing flange.

26) Machine according to claim 1, characterized by the fact that it comprises at least one container of an aromatising substance and conveying means bringing said aromatising substance to at least one mixing chamber with said water.

27) Machine according to claim 26, characterized by the fact that said mixing chamber is arranged close to said dispenser point.

28) Machine according to claim 26, characterized by the fact that said conveying means comprise at least one connecting pipe of said container to said mixing chamber.

29) Machine according to claim 28, characterized by the fact that said conveying means comprise means for pumping said aromatising substance in said connecting pipe.

30) Machine according to claim 29, characterized by the fact that said means for pumping comprise at least one peristaltic pump.

31) Machine according to claim 26, characterized by the fact that said conveying means comprise cooling means of said aromatising substance.

32) Machine according to claim 26, characterized by the fact that said conveying means comprise at least one connecting pipe of said container to said mixing chamber and cooling means of said aromatising substance, said cooling means comprising at least one section of said connecting pipe wrapped around said tank.

33) Machine according to claim 26, characterized by the fact that it comprises a plurality of said dispenser points and of said containers.
